(19) United States
(12) Patent Application Publication
(10) Pub. No.: US 2026/0287062 A1
(43) Pub. Date: Sep. 24, 2026

(54) SEAL DEVICE

(71) Applicant: MITSUBISHI HEAVY INDUSTRIES, LTD., Tokyo (JP)

(72) Inventors: Tatsuro FURUSHO, Tokyo (JP); Kohei OZAKI, Tokyo (JP); Azumi YOSHIDA, Tokyo (JP); Shin NISHIMOTO, Tokyo (JP)

(21) Appl. No.: 19/480,289

(22) PCT Filed: May 7, 2024
(86) PCT No.: PCT/JP2024/017009

§ 371 Date: Oct. 30, 2025

(30) Foreign Application Priority Data
May 19, 2023 (JP) 2023-083114

(51) Int. Cl. F16J 15/44; F16J 15/447

(52) U.S. Cl. CPC F16J 15/442; F16J 15/4472

(57) ABSTRACT

A seal device includes an annular seal ring centered on a seal axis, and a seal holding ring for holding the seal ring. The seal holding ring has an annular holding groove recessed radially inward. The seal ring has a contact surface to contact a low-pressure side groove side surface in the axial direction. The seal ring is divided into four or more in a circumferential direction with respect to the seal axis. The thrust load center radius is a radial distance between the seal axis and a thrust load center between the radially outer end of the contact surface and the position most radially inward. The inner end radius is the radial distance between the seal axis and the most radially inner end of the contact surface. The ratio of the inner end radius to the thrust load center radius is 1.20 or less.

### TECHNICAL FIELD

The present invention relates to a seal device attached around a shaft.

Priority is claimed on Japanese Patent Application No. 2023-083114 filed on May 19, 2023 the content of which is incorporated herein by reference.

### BACKGROUND ART

As a seal device attached around a shaft, for example, a seal device is disclosed in PTL 1 below.

This seal device has a seal ring facing an outer peripheral surface of a shaft, and a seal holding ring (seal ring holder) that holds the seal ring. The seal ring has an annular shape around a seal axis on a rotational axis of the shaft. The seal ring has an annular cylinder and a plurality of annular seal fins protruding toward a radial inner side with respect to the seal axis from an inner peripheral surface of the cylinder.

In a technique described in PTL 1, a guide pin that guides movement of the seal ring in a radial direction with respect to the axis is provided, so that bias of the seal ring in the radial direction with respect to the axis is suppressed.

### CITATION LIST

### Patent Literature

[PTL 1] Japanese Unexamined Patent Application Publication No. 2000-097350

### SUMMARY OF INVENTION

### Technical Problem

In the seal device described in PTL 1, the seal ring may receive a thrust load from a high-pressure side with reference to the seal ring, and a moment may be generated that tends to incline the seal axis of the seal ring with respect to the rotational axis of the shaft. In this case, when the seal axis is inclined with respect to the rotational axis due to this moment, deterioration in sealing performance, damage to a seal piece such as the seal fin, or the like may be caused.

Therefore, an object of the present disclosure is to provide a seal device capable of suppressing deterioration in sealing performance and damage to a seal piece.

### Solution to Problem

A seal device as one aspect according to the invention for achieving the above object includes a seal ring that has an annular shape around a seal axis, and a seal holding ring that has an annular shape around the seal axis and that holds the seal ring from an outer peripheral side of the seal ring.

The seal holding ring has an annular holding groove that is recessed toward a radial outer side out of a radial inner side and the radial outer side in a radial direction with respect to the seal axis. The seal ring has a seal cylinder that has an annular shape around the seal axis and that is partially inserted into the holding groove of the seal holding ring, and a plurality of seal pieces that have an annular shape around the seal axis and that are disposed on an inner peripheral side of the seal cylinder to be fixed to the seal cylinder. The seal cylinder has, out of an axial high-pressure side and an axial low-pressure side in an axial direction in which the seal axis extends, a high-pressure-side surface facing the axial high-pressure side and a low-pressure-side surface facing the axial low-pressure side. The holding groove is defined by a holding groove bottom surface facing the radial inner side, a high-pressure-side holding groove side surface facing a high-pressure-side surface of the seal cylinder in the axial direction, and a low-pressure-side holding groove side surface facing a low-pressure-side surface of the seal cylinder in the axial direction. At least a part of the low-pressure-side surface of the seal cylinder forms a contact surface of the seal ring that allows contact with the low-pressure-side holding groove side surface of the seal holding ring in the axial direction. The seal ring is divided into four or more parts in a circumferential direction with respect to the seal axis. A ratio of an inner end radius to a thrust load center radius is 1.20 or less. The thrust load center radius is a distance in the radial direction between the seal axis and a thrust load center, which is an intermediate position in the radial direction between a position closest to the radial outer side among portions of the seal ring that are in contact with the seal holding ring, and a position of the seal ring closest to the radial inner side. The inner end radius is a distance in the radial direction between the seal axis and a position of an end of the contact surface closest to the radial inner side.

The seal ring receives the thrust load from a high-pressure fluid present on the axial high-pressure side with reference to the seal ring. A moment that tends to incline the seal axis with respect to the rotational axis of the shaft may act on the seal ring due to the thrust load. When the seal ring is divided into four or more parts in the circumferential direction, in a case where such a moment acts, the seal axis is inclined with respect to the rotational axis of the shaft, which may cause deterioration in sealing performance, damage to the seal piece such as a seal fin, or the like. In the present aspect, the generation of the moment acting on the seal ring, and the inclination of the seal axis of the seal ring with respect to the rotational axis of the shaft can be suppressed.

### Advantageous Effects of Invention

According to one aspect of the present disclosure, it is possible to suppress deterioration in sealing performance and damage to a seal piece due to an inclination of a seal axis of a seal ring with respect to a rotational axis of a shaft.

### BRIEF DESCRIPTION OF DRAWINGS

FIG. 1 is a cross-sectional view of a seal device according to a first embodiment of the present disclosure.

FIG. 2 is a cross-sectional view taken along line II-II in FIG. 1.

FIG. 3 is a cross-sectional view of a seal device in a comparative example.

FIG. 4 is a graph showing a relationship between the number of divisions of the seal ring and an upper limit ratio.

FIG. 5 is a cross-sectional view of a seal device in a second embodiment according to the present disclosure.

FIG. 6 is a cross-sectional view of a seal device according to a third embodiment of the present disclosure.

FIG. 7 is a cross-sectional view of a seal device in a fourth embodiment according to the present disclosure.

### DESCRIPTION OF EMBODIMENTS

Hereinafter, various embodiments and modification examples of a seal device according to the present disclosure will be described with reference to the drawings.

### First Embodiment

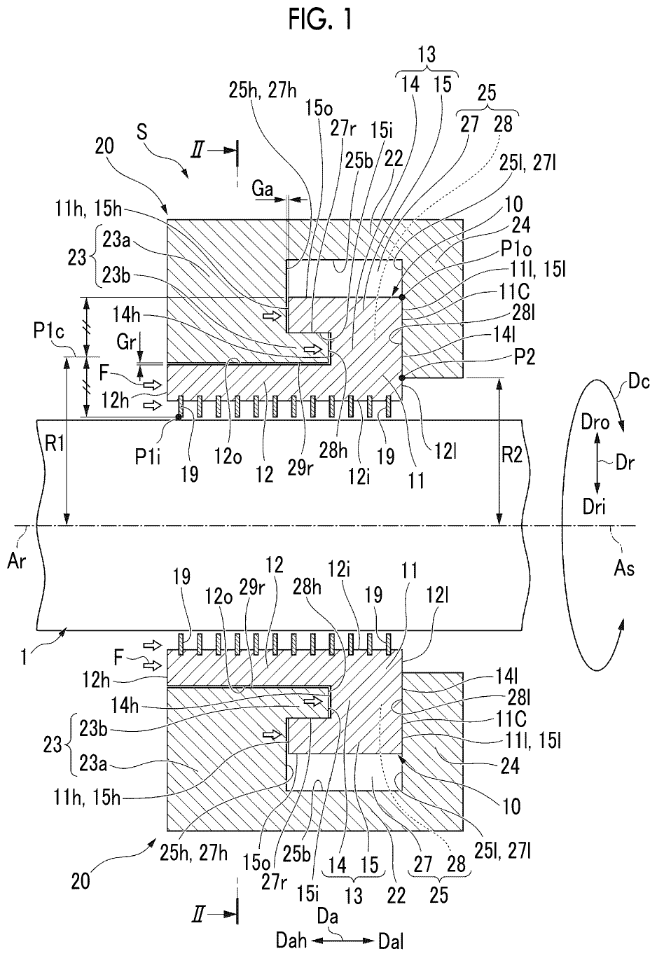

A first embodiment of a seal device will be described with reference to FIGS. 1 to 3.

As shown in FIG. 1, a seal device S in the present embodiment is a seal device provided around a shaft 1 rotatable around a rotational axis Ar. The seal device S includes a seal ring 10 that has an annular shape around a seal axis As, and a seal holding ring 20 that holds the seal ring 10 in an annular shape around the seal axis As. The seal holding ring 20 has a holding groove 25 into which a part of the seal ring 10 is inserted.

Here, a direction in which the seal axis As extends is referred to as an axial direction Da, a radial direction with respect to the seal axis As is simply referred to as a radial direction Dr, and a circumferential direction with respect to the seal axis As is simply referred to as a circumferential direction Dc. In addition, one side of both sides in the axial direction Da is referred to as an axial high-pressure side Dah, and the other side is referred to as an axial low-pressure side Dal. Furthermore, a side closer to the seal axis As in the radial direction Dr is referred to as a radial inner side Dri, and a side farther from the seal axis As in the radial direction Dr is referred to as a radial outer side Dro. In the present embodiment, in a state where the seal device S is disposed around the shaft 1, basically, the seal axis As of the seal device S is located on the above-described rotational axis Ar.

The seal device S serves to prevent a high-pressure fluid (for example, steam) present on the axial high-pressure side Dah with respect to the seal device S from flowing out to the axial low-pressure side Dal of the seal device S along an outer peripheral surface of the shaft 1.

The seal ring 10 includes a seal cylinder 11 and a plurality of seal pieces 19. The seal cylinder 11 has an annular shape around the seal axis As. The plurality of seal pieces 19 are arranged in the axial direction Da in an annular shape around the seal axis As. The plurality of seal pieces 19 are disposed on an inner peripheral side of the seal cylinder 11 and are fixed to the seal cylinder 11. Ends of the plurality of seal pieces 19 on the radial inner side Dri face the outer peripheral surface of the shaft 1 with a slight gap therebetween.

The seal cylinder 11 has a cylinder body 12 and a held portion 13 inserted into the holding groove 25. The cylinder body 12 has a cylinder inner peripheral surface 12i facing the radial inner side Dri, a body outer peripheral surface 12o facing the radial outer side Dro, a body high-pressure-side surface 12h facing the axial high-pressure side Dah, and a body low-pressure-side surface 12l facing the axial low-pressure side Dal.

The held portion 13 includes a held leg portion 14 that protrudes from the body outer peripheral surface 12o to the radial outer side Dro, and a hook portion 15 that is provided at an end of the held leg portion 14 on the radial outer side Dro and that protrudes from the held leg portion 14 toward the axial high-pressure side Dah. The held leg portion 14 has a leg high-pressure-side surface 14h facing the axial high-pressure side Dah and a leg low-pressure-side surface 14l facing the axial low-pressure side Dal. The hook portion 15 has a hook outer peripheral surface 150 facing the radial outer side Dro, a hook inner peripheral surface 15i facing the radial inner side Dri, a hook high-pressure-side surface 15h facing the axial high-pressure side Dah, and a hook low-pressure-side surface 15l facing the axial low-pressure side Dal. The body low-pressure-side surface 12l, the leg low-pressure-side surface 14l, and the hook low-pressure-side surface 15l are flush with each other. The body low-pressure-side surface 12l, the leg low-pressure-side surface 14l, and the hook low-pressure-side surface 15l form a low-pressure-side surface 11l of the seal cylinder 11. The hook outer peripheral surface 150 extends from an end of the hook low-pressure-side surface 15l on the radial outer side Dro toward the axial high-pressure side Dah. The hook inner peripheral surface 15i extends from an end of the leg high-pressure-side surface 14h on the radial outer side Dro toward the axial high-pressure side Dah. The leg high-pressure-side surface 14h is located on the axial low-pressure side Dal with respect to the body high-pressure-side surface 12h. The hook high-pressure-side surface 15h is located on the axial low-pressure side Dal with respect to the body high-pressure-side surface 12h and on the axial high-pressure side Dah with respect to the leg high-pressure-side surface 14h. The hook high-pressure-side surface 15h connects an end of the hook outer peripheral surface 15o on the axial high-pressure side Dah and an end of the hook inner peripheral surface 15i on the axial high-pressure side Dah. The body high-pressure-side surface 12h, the leg high-pressure-side surface 14h, and the hook high-pressure-side surface 15h form a high-pressure-side surface 11h of the seal cylinder 11.

The seal holding ring 20 has a holding ring cylinder 22, a high-pressure-side wall member 23, and a low-pressure-side wall member 24. The holding ring cylinder 22 has a cylindrical shape around the seal axis As. The high-pressure-side wall member 23 includes a high-pressure-side first wall member 23a and a high-pressure-side second wall member 23b. The high-pressure-side first wall member 23a is provided on the axial high-pressure side Dah of the holding ring cylinder 22, and protrudes from a portion of the holding ring cylinder 22 on the axial high-pressure side Dah to the radial inner side Dri. The high-pressure-side second wall member 23b is provided on the radial inner side Dri of the high-pressure-side first wall member 23a, and protrudes from a portion of the high-pressure-side first wall member 23a on the radial inner side Dri toward the axial low-pressure side Dal. The low-pressure-side wall member 24 is provided on the axial low-pressure side Dal of the holding ring cylinder 22, and protrudes from a portion of the holding ring cylinder 22 on the axial low-pressure side Dal to the radial inner side Dri. The holding groove 25 is formed between the high-pressure-side wall member 23 and the low-pressure-side wall member 24 in the axial direction Da on the radial inner side Dri of the holding ring cylinder 22.

The holding groove 25 is an annular groove that is recessed to the radial outer side Dro and centered on the seal axis As. The holding groove 25 has a hook insertion groove portion 27 and a leg insertion groove portion 28.

The hook insertion groove portion 27 is a portion into which the hook portion 15 of the seal ring 10 is inserted. The width of the hook insertion groove portion 27 in the axial direction Da is greater than the width of the hook portion 15 in the axial direction Da. The hook insertion groove portion 27 is defined by a holding groove bottom surface 25b, a radial movement restriction surface 27r, a high-pressure-side holding groove first side surface 27h, and a low-pressure-side holding groove first side surface 27l. The holding groove bottom surface 25b is formed on a surface of the holding ring cylinder 22 facing the radial inner side Dri. The holding groove bottom surface 25b faces the hook outer peripheral surface 15o in the radial direction Dr. The radial movement restriction surface 27r is formed on a surface of the high-pressure-side second wall member 23b facing the radial outer side Dro. The radial movement restriction surface 27r faces the holding groove bottom surface 25b in the radial direction Dr. Furthermore, the radial movement restriction surface 27r faces the hook inner peripheral surface 15i in the radial direction Dr. The high-pressure-side holding groove first side surface 27h is formed on a surface of the high-pressure-side first wall member 23a facing the axial low-pressure side Dal. The high-pressure-side holding groove first side surface 27h faces the hook high-pressure-side surface 15h in the axial direction Da. The high-pressure-side second wall member 23b of the seal holding ring 20 is in a back-to-back relationship with the radial movement restriction surface 27r and has a high-pressure-side inner peripheral surface 29r facing the radial inner side Dri. The high-pressure-side inner peripheral surface 29r faces the body outer peripheral surface 12o of the seal cylinder 11 in the radial direction Dr. The low-pressure-side holding groove first side surface 27l is formed on a surface of the low-pressure-side wall member 24 facing the axial high-pressure side Dah. The low-pressure-side holding groove first side surface 27l faces the high-pressure-side holding groove first side surface 27h in the axial direction Da. Furthermore, the low-pressure-side holding groove first side surface 27l faces the hook high-pressure-side surface 15h in the axial direction Da.

The leg insertion groove portion 28 is a portion into which the held leg portion 14 of the seal ring 10 is inserted. The width of the leg insertion groove portion 28 in the axial direction Da is greater than the width of the held leg portion 14 in the axial direction Da and smaller than the width of the hook portion 15 in the axial direction Da. In addition, the leg insertion groove portion 28 is located on the radial inner side Dri of the hook insertion groove portion 27 and communicates with the hook insertion groove portion 27. The leg insertion groove portion 28 is defined by a high-pressure-side holding groove second side surface 28h and a low-pressure-side holding groove second side surface 28l. The high-pressure-side holding groove second side surface 28h is formed on a surface of the high-pressure-side second wall member 23b facing the axial low-pressure side Dal. The high-pressure-side holding groove second side surface 28h faces the leg high-pressure-side surface 14h in the axial direction Da. The high-pressure-side holding groove second side surface 28h and the high-pressure-side holding groove first side surface 27h form a high-pressure-side holding groove side surface 25h of the holding groove 25. The low-pressure-side holding groove second side surface 28l is formed on a surface of the low-pressure-side wall member 24 facing the axial high-pressure side Dah. The low-pressure-side holding groove second side surface 28l faces the high-pressure-side holding groove second side surface 28h in the axial direction Da. Furthermore, the low-pressure-side holding groove second side surface 28l faces the leg low-pressure-side surface 14l in the axial direction Da. The low-pressure-side holding groove second side surface 28l is flush with the low-pressure-side holding groove first side surface 27l. The low-pressure-side holding groove second side surface 28l and the low-pressure-side holding groove first side surface 27l form a low-pressure-side holding groove side surface 25l of the holding groove 25.

A gap Ga is present between the high-pressure-side holding groove first side surface 27h and the hook high-pressure-side surface 15h facing each other in the axial direction Da. In addition, a gap Gr is present between the high-pressure-side inner peripheral surface 29r and the body outer peripheral surface 12o facing each other in the radial direction Dr. In this way, since the gaps Ga and Gr are present between the seal ring 10 and the seal holding ring 20, the seal ring 10 can be inclined with respect to the seal holding ring 20.

A portion of the low-pressure-side surface 11l of the seal ring 10 that is on the radial outer side Dro forms a contact surface 11C that can come into contact with the low-pressure-side holding groove side surface 25l of the holding groove 25.

Here, an intermediate position in the radial direction Dr between a position P1o of the seal ring 10 closest to the radial outer side Dro among portions of the seal ring 10 that are in contact with the seal holding ring 20, and a position P1i of the seal ring 10 closest to the radial inner side Dri is referred to as a thrust load center P1c. The position P1i of the seal ring 10 closest to the radial inner side Dri is an end of the seal piece 19 on the radial inner side Dri. In addition, the position P1o of the seal ring 10 closet to on the radial outer side Dro among the portions of the seal ring 10 that are in contact with the seal holding ring 20 is an end of the contact surface 11C on the radial outer side Dro in the present embodiment. The seal ring 10 receives a thrust load F that is directed from the high-pressure fluid present on the axial high-pressure side Dah of the seal device S toward the axial low-pressure side Dal. The above-described thrust load center P1c is a center of a region, in the radial direction Dr, where the thrust load F is received by the seal ring 10.

In addition, a distance in the radial direction Dr between the thrust load center P1c and the seal axis As is referred to as a thrust load center radius RI. In addition, a distance in the radial direction Dr between the seal axis As and a position P2 of the end of the contact surface 11C closer to the radial inner side Dri is defined as an inner end radius R2.

In the present embodiment, a ratio (R2/R1) of the inner end radius R2 to the thrust load center radius R1 is 1.0 or less. That is, R2/R1≤1.

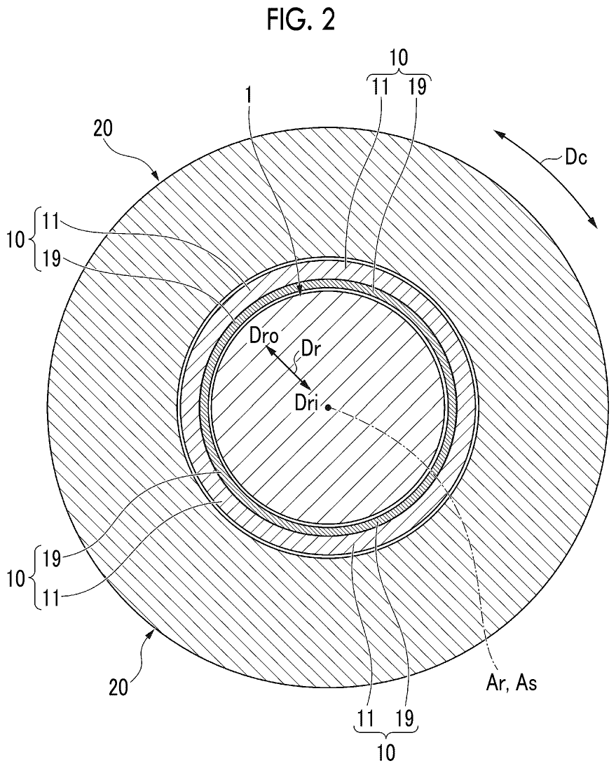

As shown in FIG. 2, both the seal ring 10 and the seal holding ring 20 in the present embodiment are divided into a plurality of parts in the circumferential direction Dc. Specifically, the seal ring 10 is divided into four parts in the circumferential direction De, and the seal holding ring 20 is divided into two parts in the circumferential direction De, for example.

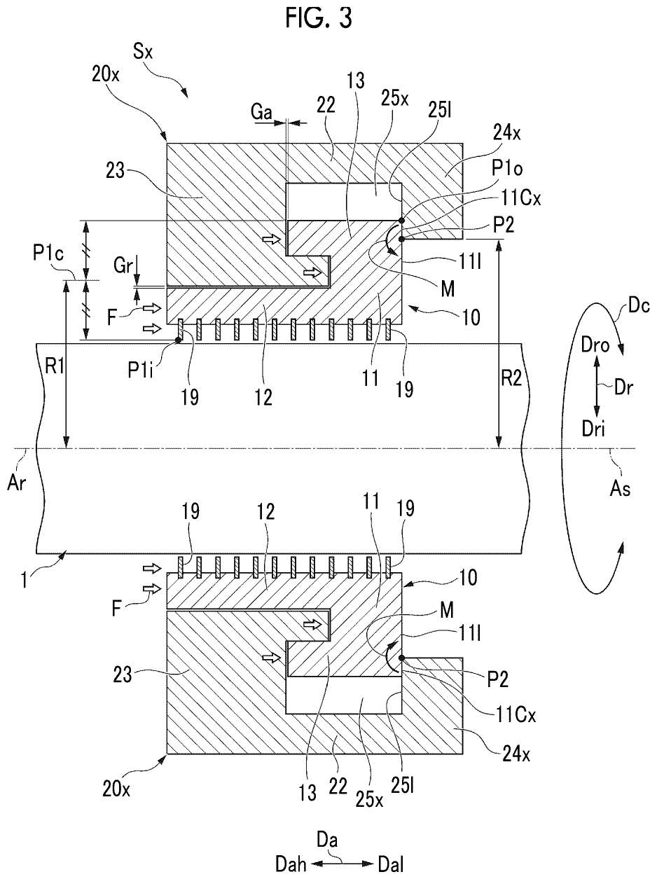

Next, in order to describe the effects of the seal device S in the present embodiment, a comparative example will be described with reference to FIG. 3.

A seal device Sx in the comparative example also includes the seal ring 10 and a seal holding ring 20x that holds the seal ring 10, as in the seal device S in the present embodiment. The seal ring 10 in the comparative example is completely identical to the seal ring 10 in the present embodiment. The seal holding ring 20x in the comparative example is substantially identical to the seal holding ring 20 in the present embodiment. Therefore, the seal holding ring 20x in the comparative example also has the holding ring cylinder 22, the high-pressure-side wall member 23, and a low-pressure-side wall member 24x, as in the seal holding ring 20 in the present embodiment. A holding groove 25x in the comparative example is also formed between the high-pressure-side wall member 23 and the low-pressure-side wall member 24x in the axial direction Da on the radial inner side Dri of the holding ring cylinder 22. Also in this comparative example, a portion of the low-pressure-side surface 11l of the seal ring 10, which can come into contact with the low-pressure-side holding groove side surface 25l of the holding groove 25x, forms a contact surface 11Cx. In addition, also in this comparative example, since the gaps Ga and Gr are present between the seal ring 10 and the seal holding ring 20x, the seal ring 10 can be inclined with respect to the seal holding ring 20x.

As in the low-pressure-side wall member 24 in the present embodiment, the low-pressure-side wall member 24x in the comparative example is also provided on the axial low-pressure side Dal of the holding ring cylinder 22 and protrudes from the portion of the holding ring cylinder 22 on the axial low-pressure side Dal to the radial inner side Dri. However, the amount of protrusion of the low-pressure-side wall member 24x toward the radial inner side Dri in the comparative example is smaller than the amount of protrusion of the low-pressure-side wall member 24 toward the radial inner side Dri in the present embodiment. For this reason, the position P2 of the end of the contact surface 11Cx on the radial inner side Dri in the comparative example is located on the radial outer side Dro with respect to the position P2 of the end of the contact surface 11C on the radial inner side Dri in the present embodiment. As a result, the ratio (R2/R1) of the inner end radius R2 to the thrust load center radius R1 in the comparative example is greater than the ratio (R2/R1) of the inner end radius R2 to the thrust load center radius R1 in the present embodiment. Specifically, the ratio (R2/R1) in the comparative example is, for example, about 1.25.

The seal ring 10 in the comparative example is also divided into four parts in the circumferential direction De, as in the seal ring 10 in the present embodiment.

In the comparative example described above, when the seal ring 10 receives the thrust load F from the high-pressure fluid present on the axial high-pressure side Dah, a moment M acts, which relatively displaces a portion of the seal axis As on the axial high-pressure side Dah to the radial outer side Dro with respect to the rotational axis Ar around the position P2 of the end of the contact surface 11Cx on the radial inner side Dri. Specifically, in the example shown in FIG. 3, a counterclockwise moment M acts on a portion above the seal axis As with the position P2 of the end of the contact surface 11Cx on the radial inner side Dri as a center, and a counterclockwise moment M acts on a portion below the seal axis As with the position P2 of the end of the contact surface 11Cx on the radial inner side Dri as a center.

In a case where the seal ring 10 is not divided in the circumferential direction Dc, the counterclockwise moment M acting on the portion above the seal axis As is canceled by the counterclockwise moment M acting on the portion below the seal axis As. Therefore, the seal axis As is not inclined with respect to the rotational axis Ar.

However, when the number of divisions of the seal ring 10 in the circumferential direction De increases, the amount by which a moment M in a cross section including the seal axis As at a predetermined position in the circumferential direction Dc is canceled by a moment M in a cross section including the seal axis As at another position in the circumferential direction De decreases. For this reason, when the number of divisions of the seal ring 10 in the circumferential direction Dc is large, the seal axis As is inclined with respect to the rotational axis Ar, which may cause deterioration in sealing performance, damage to the seal piece 19, or the like.

As in the comparative example, in a case where the ratio (R2/R1) is about 1.25 and the seal ring 10 is divided into four parts in the circumferential direction Dc, the seal axis As is inclined with respect to the rotational axis Ar due to the thrust load F received from the high-pressure fluid.

In the present embodiment, as in the comparative example, the seal ring 10 is divided into four parts in the circumferential direction Dc. However, since the ratio (R2/R1) is at most 1.0 or less, even when the seal ring 10 receives the thrust load F from the high-pressure fluid, a moment M that causes the seal axis As to be inclined with respect to the rotational axis Ar does not act on the individual parts of the seal ring 10 divided into four parts. Therefore, in the present embodiment, even when the thrust load F is received from the high-pressure fluid, the seal axis As of the seal ring 10 is not substantially inclined with respect to the rotational axis Ar, so that deterioration in sealing performance or damage to the seal piece 19 can be suppressed.

### Second Embodiment

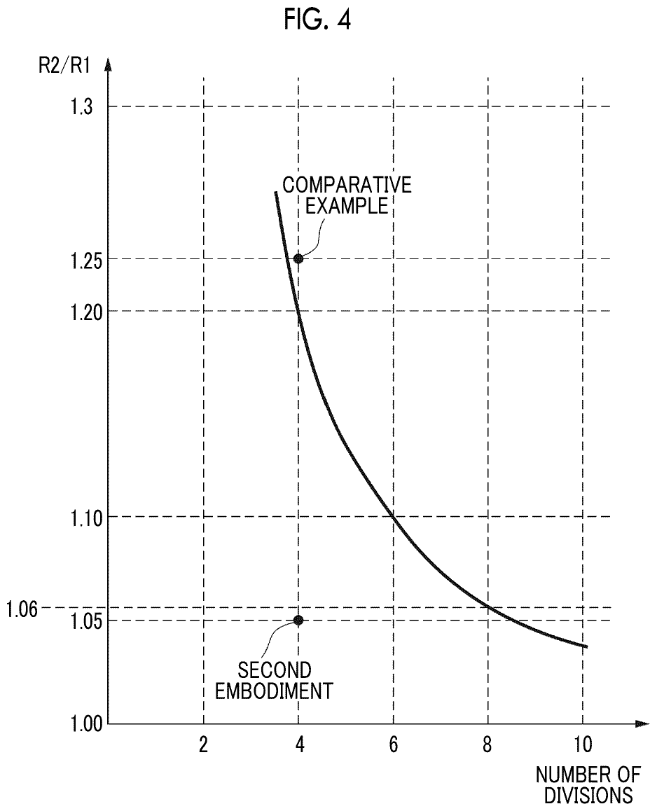

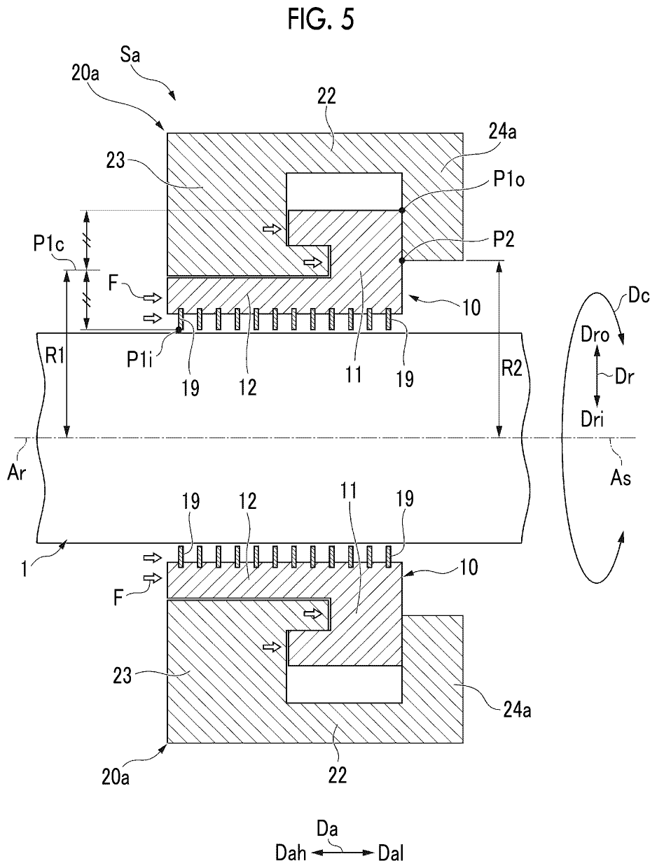

A second embodiment of the seal device will be described with reference to FIGS. 4 and 5.

FIG. 4 is a graph showing a relationship between the number of divisions of the seal ring and an upper limit ratio (R2/R1) at which the seal axis As is not substantially inclined with respect to the rotational axis Ar even when the seal ring receives the thrust load F from the high-pressure fluid.

As described above, when the number of divisions of the seal ring in the circumferential direction De increases, the amount by which the moment M in the cross section including the seal axis As at the predetermined position in the circumferential direction De is canceled by the moment M in the cross section including the seal axis As at another position in the circumferential direction Dc decreases. For this reason, as shown in the graph of FIG. 4, an upper limit ratio U (R2/R1) decreases as the number of divisions increases. However, the upper limit ratio U (R2/R1) does not become smaller than 1.0.

Specifically, when the number of divisions of the seal ring is 4, the upper limit ratio U (R2/R1) is 1.2. Therefore, in a case where the number of divisions of the seal ring is four, the ratio (R2/R1) is set to 1.2 or less, so that even when the seal ring receives the thrust load F from the high-pressure fluid, the seal axis As is not substantially inclined with respect to the rotational axis Ar. In the seal ring 10 in the comparative example described above, the number of divisions is 4 and the ratio (R2/R1) is 1.25. Therefore, when the seal ring 10 receives the thrust load F from the high-pressure fluid, the seal axis As is inclined with respect to the rotational axis Ar.

When the number of divisions of the seal ring is 6, the upper limit ratio U (R2/R1) is 1.1. For this reason, in a case where the number of divisions of the seal ring is 6, the ratio (R2/R1) is set to 1.1 or less, so that even when the seal ring receives the thrust load F from the high-pressure fluid, the seal axis As is not substantially inclined with respect to the rotational axis Ar.

When the number of divisions of the seal ring is 8, the upper limit ratio U (R2/R1) is 1.06. Therefore, in a case where the number of divisions of the seal ring is 8, the ratio (R2/R1) is set to 1.06 or less, so that even when the seal ring receives the thrust load F from the high-pressure fluid, the seal axis As is not substantially inclined with respect to the rotational axis Ar.

The seal device in the present embodiment is a seal device based on the above-described viewpoint. As shown in FIG. 5, a seal device Sa in the present embodiment also includes the seal ring 10 and a seal holding ring 20a that holds the seal ring 10, as in the seal device S in the first embodiment. The seal ring 10 in the present embodiment has the same number of divisions as the seal ring 10 in the first embodiment, that is, four. The seal holding ring 20a in the present embodiment also has the holding ring cylinder 22, the high-pressure-side wall member 23, and a low-pressure-side wall member 24a, as in the seal holding ring 20. However, the amount of protrusion of a low-pressure-side wall member 24a in the present embodiment from the holding ring cylinder 22 to the radial inner side Dri is greater than the amount of protrusion of the low-pressure-side wall member 24x in the above-described comparative example from the holding ring cylinder 22 to the radial inner side Dri, but is smaller than the amount of protrusion of the low-pressure-side wall member 24 in the first embodiment from the holding ring cylinder 22 to the radial inner side Dri. In this relationship, the ratio (R2/R1) of the seal device Sa in the present embodiment is greater than the ratio (R2/R1) in the first embodiment, and is 1.05.

The ratio (R2/R1) of the seal device Sa in the present embodiment is 1.05, which is greater than the ratio (R2/R1) of the seal device S in the first embodiment, but is equal to or smaller than the upper limit ratio U (R2/R1=1.2) in a case where the number of divisions is 4. Therefore, also in the present embodiment, even when the thrust load F is received from the high-pressure fluid, the seal axis As of the seal ring 10 is not substantially inclined with respect to the rotational axis Ar, so that deterioration in sealing performance or damage to the seal piece 19 can be suppressed.

In the seal device Sa of the present embodiment, the number of divisions of the seal ring 10 is four. However, in a case where the number of divisions of the seal ring 10 is six, the ratio (R2/R1) may be equal to or less than the upper limit ratio U (R2/R1=1.1), and in a case where the number of divisions of the seal ring 10 is eight, the ratio (R2/R1) may be equal to or less than the upper limit ratio U (R2/R1=1.06).

### Third Embodiment

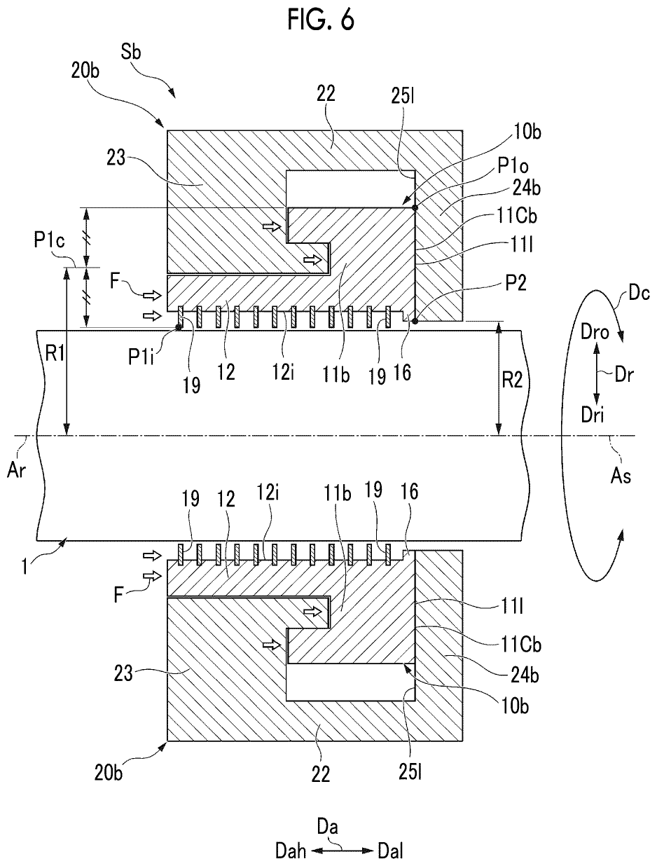

A third embodiment of the seal device will be described with reference to FIG. 6.

As shown in FIG. 6, a seal device Sb in the present embodiment also includes a seal ring 10b and a seal holding ring 20b that holds the seal ring 10b, as in the seal device S in the first embodiment.

The seal ring 10b in the present embodiment also has a seal cylinder 11b and the plurality of seal pieces 19, as in the seal ring 10 in the first embodiment. The seal cylinder 11b has an annular shape around the seal axis As. The plurality of seal pieces 19 are arranged in the axial direction Da in an annular shape around the seal axis As. The plurality of seal pieces 19 are disposed on the inner peripheral side of the seal cylinder 11b and are fixed to the seal cylinder 11b. As described above, the seal cylinder 11b of the present embodiment has the cylinder inner peripheral surface 12i from which the plurality of seal pieces 19 protrude toward the radial inner side Dri. The seal cylinder 11b further includes a protrusion portion 16 that protrudes to the radial inner side Dri from a portion of the cylinder inner peripheral surface 12i on the axial low-pressure side Dal. A surface of the protrusion portion 16 facing the axial low-pressure side Dal is a part of the low-pressure-side surface 11l of the seal cylinder 11b. In addition, the seal ring 10b in the present embodiment is also divided into four parts in the circumferential direction De, as in the seal ring 10 in the first embodiment.

The seal holding ring 20b in the present embodiment also has the holding ring cylinder 22, the high-pressure-side wall member 23, and a low-pressure-side wall member 24b, as in the seal holding ring 20 in the first embodiment. The holding groove 25 in the present embodiment is also formed between the high-pressure-side wall member 23 and the low-pressure-side wall member 24b in the axial direction Da on the radial inner side Dri of the holding ring cylinder 22. The amount of protrusion of the low-pressure-side wall member 24b in the present embodiment from the holding ring cylinder 22 to the radial inner side Dri is greater than the amount of protrusion of the low-pressure-side wall member 24 in the first embodiment from the holding ring cylinder 22 to the radial inner side Dri. For this reason, an end of the low-pressure-side holding groove side surface 25l on the radial inner side Dri in the present embodiment is located on the radial inner side Dri with respect to the end of the low-pressure-side holding groove side surface 25l on the radial inner side Dri in the first embodiment. The low-pressure-side holding groove side surface 25l is in contact with the low-pressure-side surface 11l of the seal cylinder 11b. Therefore, in the present embodiment, at least a part of the low-pressure-side surface 11l of the seal cylinder 11b forms a contact surface 11Cb of the seal ring 10b.

The position P2 of the end of the contact surface 11Cb on the radial inner side Dri in the present embodiment is located on the radial inner side Dri with respect to the cylinder inner peripheral surface 12i of the seal cylinder 11b and on the radial inner side Dri with respect to the position P2 of the end of the contact surface 11C on the radial inner side Dri in the first embodiment. For this reason, the inner end radius R2, which is the distance in the radial direction Dr between the seal axis As and the end of the contact surface 11Cb closest to the radial inner side Dri, is smaller than the inner end radius R2 in the first embodiment.

As described above, since the inner end radius R2 in the present embodiment is smaller than the inner end radius R2 in the first embodiment, the ratio (R2/R1) in the present embodiment is smaller than the ratio (R2/R1) in the first embodiment. Therefore, the ratio (R2/R1) in the present embodiment is also 1.0 or less, as in the ratio (R2/R1) in the first embodiment. Therefore, also in the present embodiment, even when the thrust load F is received from the high-pressure fluid, the seal axis As of the seal ring 10b is not substantially inclined with respect to the rotational axis Ar, so that deterioration in sealing performance or damage to the seal piece 19 can be suppressed.

As described above, as the number of divisions of the seal ring increases, the upper limit ratio U (R2/R1) gradually decreases. Therefore, in a case where the number of divisions of the seal ring is 6 or more, as in the present embodiment, it is effective to provide the protrusion portion 16 in the seal cylinder 11b of the seal ring 10b to reduce the inner end radius R2.

### Fourth Embodiment

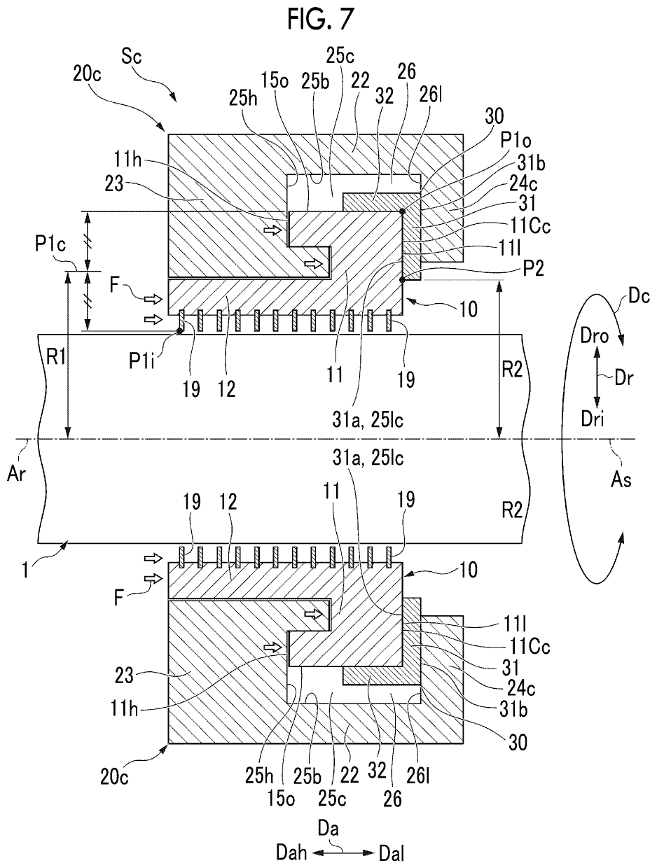

A fourth embodiment of the seal device will be described with reference to FIG. 7.

As shown in FIG. 7, a seal device Sc in the present embodiment also includes the seal ring 10 and a seal holding ring 20c that holds the seal ring 10, as in the seal device S in the first embodiment.

The seal ring 10 in the present embodiment is the same as the seal ring 10 in the first embodiment.

The seal holding ring 20c in the present embodiment includes a holding ring body 21 and a spacer 30. The holding ring body 21 has the holding ring cylinder 22, the high-pressure-side wall member 23, and a low-pressure-side wall member 24c, as in the seal holding ring 20 in the first embodiment. An annular groove 26 that is recessed to the radial outer side Dro and that is centered around the seal axis As is formed between the high-pressure-side wall member 23 and the low-pressure-side wall member 24c in the axial direction Da on radial inner side Dri of the holding ring cylinder 22. The groove 26 is defined by the holding groove bottom surface 25b facing the radial inner side Dri, the high-pressure-side holding groove side surface 25h facing the high-pressure-side surface 11h of the seal cylinder 11 in the axial direction Da, and a low-pressure-side groove side surface 26l facing the low-pressure-side surface 11l of the seal cylinder 11 in the axial direction Da. The holding groove bottom surface 25b is formed on a surface of the holding ring cylinder 22 facing the radial inner side Dri. The high-pressure-side holding groove side surface 25h is formed on a surface of the high-pressure-side wall member 23 facing the axial low-pressure side Dal. The low-pressure-side groove side surface 26l is formed on a surface of the low-pressure-side wall member 24c facing the axial high-pressure side Dah.

The spacer 30 has a ring disk portion 31 having a ring disk shape around the seal axis As, and a tubular portion 32 having a cylindrical shape around the seal axis As. The tubular portion 32 extends from a portion of the ring disk portion 31 on the radial outer side Dro toward the axial high-pressure side Dah. The inner peripheral surface of the tubular portion 32 faces or comes into contact with the hook outer peripheral surface 15o of the seal cylinder 11. The ring disk portion 31 has a disk first side surface 31a facing the axial high-pressure side Dah and a disk second side surface 31b facing the axial low-pressure side Dal. The ring disk portion 31 is located between the low-pressure-side surface 11l of the seal cylinder 11 and the low-pressure-side groove side surface 26l of the groove 26. The disk first side surface 31a of the ring disk portion 31 comes into contact with the low-pressure-side surface 11l of the seal cylinder 11. The disk second side surface 31b of the ring disk portion 31 comes into contact with the low-pressure-side groove side surface 26l of the groove 26. An end of the ring disk portion 31 on the radial inner side Dri protrudes to the radial inner side Dri from an end of the low-pressure-side wall member 24c of the holding ring body 21 on the radial inner side Dri.

The holding groove 25c in the present embodiment is formed by the groove 26 of the holding ring body 21 and the spacer 30. The holding groove 25c is defined by a surface having the holding groove bottom surface 25b of the groove 26, the high-pressure-side holding groove side surface 25h of the groove 26, a part of the low-pressure-side groove side surface 26l of the groove 26, and the disk first side surface 31a of the spacer 30. A low-pressure-side holding groove side surface 25lc of the holding groove 25c has a portion of the low-pressure-side groove side surface 26l of the groove 26 and the disk first side surface 31a of the spacer 30.

A contact surface 11Cc in the surface of the seal ring 10, which can come into contact with the seal holding ring 20c in the axial direction Da, is a portion in the low-pressure-side surface 11l of the seal cylinder 11, which can come into contact with the disk first side surface 31a of the spacer 30, which is a portion of the low-pressure-side holding groove side surface 25lc of the holding groove 25c. In the present embodiment, the position P2 of the end of the contact surface 11Cc on the radial inner side Dri is an end of the disk first side surface 31a of the spacer 30 on the radial inner side Dri. Therefore, the inner end radius R2 in the present embodiment is a distance in the radial direction Dr between the seal axis As and the end of the disk first side surface 31a of the spacer 30 on the radial inner side Dri. In addition, in the present embodiment, the ratio (R2/R1) of the inner end radius R2 to the thrust load center radius R1 is 1.0 or less, as in the first embodiment. Therefore, also in the present embodiment, even when the thrust load F is received from the high-pressure fluid, the seal axis As of the seal ring 10 is not substantially inclined with respect to the rotational axis Ar, so that deterioration in sealing performance or damage to the seal piece 19 can be suppressed.

The position P2 of the end of the contact surface 11Cc on the radial inner side Dri in the present embodiment is located on the radial inner side Dri with respect to the end of the low-pressure-side wall member 24c of the holding ring body 21 on the radial inner side Dri. Therefore, in a case where, for some reason, the end of the low-pressure-side wall member 24c on the radial inner side Dri is located on the radial outer side Dro with respect to the end of the low-pressure-side wall member 24 or 24a on the radial inner side Dri in the first embodiment or the second embodiment and the ratio (R2/R1) cannot be made equal to or less than the upper limit ratio U (R2/R1), it is effective to provide the spacer 30 as in the present embodiment.

### Modification Example

The seal devices S, Sa, Sb, and Sc in the above-described embodiments are fin seal devices or labyrinth seal devices each having a plurality of fins as the plurality of seal pieces 19. However, the seal devices may be brush seal devices each having a plurality of wires as a plurality of seal pieces, leaf seal devices each having a plurality of thin plates as a plurality of seal pieces, or the like.

In addition, the present disclosure is not limited to each of the embodiments described above. Various additions, modifications, substitutions, partial deletions, and the like can be made without departing from the conceptual idea and gist of the present invention derived from the contents defined in the claims and equivalents thereof.

### Additional Notes

The seal devices S, Sa, Sb, and Sc in the above-described embodiments and modification examples are understood as follows, for example.

(1) A seal device in a first aspect includes a seal ring 10 or 10b that has an annular shape around a seal axis As, and a seal holding ring 20, 20a, 20b, or 20c that has an annular shape around the seal axis As and that holds the seal ring 10 or 10b from an outer peripheral side of the seal ring 10 or 10b.

The seal holding ring 20, 20a, 20b, or 20c has an annular holding groove 25 or 25c that is recessed toward a radial outer side Dro out of a radial inner side Dri and the radial outer side Dro in a radial direction Dr with respect to the seal axis As. The seal ring 10 or 10b has a seal cylinder 11 or 11b that has an annular shape around the seal axis As and that is partially inserted into the holding groove 25 or 25c of the seal holding ring 20, 20a, 20b, or 20c, and a plurality of seal pieces 19 that have an annular shape around the seal axis As and that are disposed on an inner peripheral side of the seal cylinder 11 or 11b to be fixed to the seal cylinder 11 or 11b. The seal cylinder 11 or 11b has, out of an axial high-pressure side Dah and an axial low-pressure side Dal in an axial direction Da in which the seal axis As extends, a high-pressure-side surface 11h facing the axial high-pressure side Dah and a low-pressure-side surface 11l facing the axial low-pressure side Dal. The holding groove 25 or 25c is defined by a holding groove bottom surface 25b facing the radial inner side Dri, a high-pressure-side holding groove side surface 25h facing a high-pressure-side surface 11h of the seal cylinder 11 or 11b in the axial direction Da, and a low-pressure-side holding groove side surface 25l or 25lc facing a low-pressure-side surface 11l of the seal cylinder 11 or 11b in the axial direction Da. At least a part of the low-pressure-side surface 11l of the seal cylinder 11 or 11b forms a contact surface 11C, 11Cb, or 11Cc of the seal ring 10 or 10b that allows contact with the low-pressure-side holding groove side surface 25l and 25lc of the seal holding ring 20, 20a, 20b, or 20c in the axial direction Da. The seal ring 10 or 10b is divided into four or more parts in a circumferential direction De with respect to the seal axis As. A ratio (R2/R1) of the inner end radius R2 to the thrust load center radius R1 is 1.20 or less. The thrust load center radius R1 is a distance in the radial direction Dr between the seal axis As and a thrust load center P1c, which is an intermediate position in the radial direction Dr between a position P1o closest to the radial outer side Dro among portions of the seal ring 10 or 10b that are in contact with the seal holding ring 20, 20a, 20b, or 20c, and a position P1i of the seal ring 10, or 10b closest to the radial inner side Dri. The inner end radius R2 is a distance in the radial direction Dr between the seal axis As and a position P2 of an end of the contact surface 11C, 11Cb, or 11Cc closest to the radial inner side Dri.

The seal ring 10 or 10b receives the thrust load F from the high-pressure fluid present on the axial high-pressure side Dah with reference to the seal ring 10 or 10b. A moment M that attempts to incline the seal axis As with respect to the rotational axis Ar of the shaft 1 may act on the seal ring 10 or 10b due to the thrust load F. When the seal ring 10 or 10b is divided into four or more parts in the circumferential direction Dc, in a case where such a moment M acts, the seal axis As is inclined with respect to the rotational axis Ar of the shaft 1, which may cause deterioration in sealing performance, damage to the seal piece 19 such as a seal fin, or the like. In the present aspect, the generation of the moment M acting on the seal ring 10 or 10b can be suppressed, and the inclination of the seal axis As of the seal ring 10 or 10b with respect to the rotational axis Ar of the shaft I can be suppressed.

(2) A seal device according to a second aspect is the seal device according to the first aspect, in which the seal ring 10 is divided into six parts in the circumferential direction Dc.

The ratio (R2/R1) of the inner end radius R2 to the thrust load center radius R1 is 1.10 or less.

In the present aspect, even when the seal ring 10 is divided into six parts in the circumferential direction De, the generation of the moment M acting on the seal ring 10 can be suppressed, and the inclination of the seal axis As with respect to the rotational axis Ar of the shaft 1 can be suppressed.

(3) A seal device according to a third aspect is the seal device according to the first aspect, in which the seal ring 10 is divided into eight parts in the circumferential direction Dc.

The ratio (R2/R1) of the inner end radius R2 to the thrust load center radius R1 is 1.06 or less.

In the present aspect, even when the seal ring 10 is divided into eight parts in the circumferential direction De, the generation of the moment M acting on the seal ring 10 can be suppressed, and the inclination of the seal axis As with respect to the rotational axis Ar of the shaft I can be suppressed.

(4) A seal device according to a fourth aspect is the seal device according to the first aspect, in which the ratio (R2/R1) of the inner end radius R2 to the thrust load center radius R1 is 1.0 or less.

In the present aspect, regardless of the number of divisions of the seal ring 10, the generation of the moment M acting on the seal ring 10 can be suppressed, and the inclination of the seal axis As with respect to the rotational axis Ar of the shaft 1 can be suppressed.

(5) A seal device according to a fifth aspect is the seal device according to any one of the first to fourth aspects, in which the seal cylinder 11b has a cylinder inner peripheral surface 12i which faces the inner peripheral side and from which the plurality of seal pieces 19 protrude toward the radial inner side Dri, and a protrusion portion 16 that protrudes from the axial low-pressure side Dal of the cylinder inner peripheral surface 12i toward the radial inner side Dri.

At least a part of a surface of the protrusion portion 16 facing the axial low-pressure side Dal forms a part of the contact surface 11Cb.

In the present aspect, the protrusion portion 16 is provided in the seal cylinder 11b, so that the end of the contact surface 11Cb closest to the radial inner side Dri can be easily brought close to the seal axis As. Therefore, in the present aspect, the inner end radius R2 can be easily reduced, and the ratio (R2/R1) of the inner end radius R2 to the thrust load center radius R1 can also be easily reduced.

(6) A seal device according to a sixth aspect is the seal device according to any one of the first to fourth aspects, in which the seal holding ring 20c has a holding ring body 21 that has an annular shape around the seal axis As and that has an annular groove 26 that is recessed toward the radial outer side Dro, and a spacer 30 that has a portion entering the groove 26.

The holding groove 25c is formed by the spacer 30 and the groove 26. The spacer 30 comes into contact with at least a part of a low-pressure-side groove side surface 26l facing the axial high-pressure side Dah, among surfaces defining the groove 26, and comes into contact with at least a part of the low-pressure-side surface Ill of the seal cylinder 11. The end of the contact surface 11Cc closest to the radial inner side Dri is an end closest to the radial inner side Dri in a surface of the low-pressure-side surface 11l of the seal cylinder 11 that is in contact with the spacer 30.

In the present aspect, the spacer 30 is provided, so that the end of the contact surface 11Cc closest to the radial inner side Dri can be easily brought close to the seal axis As. Therefore, in the present aspect, the inner end radius R2 can be easily reduced, and the ratio (R2/R1) of the inner end radius R2 to the thrust load center radius R1 can also be easily reduced.

(7) A seal device according to a seventh aspect is the seal device according to any one of the first to sixth aspects, in which the seal cylinder 11 or 11b has a cylinder body 12 and a held portion 13 inserted into the holding groove 25 or 25c.

The cylinder body 12 has a cylinder inner peripheral surface 12i which faces the radial inner side Dri and from which the plurality of seal pieces 19 protrude toward the radial inner side Dri, and a body outer peripheral surface 12o facing the radial outer side Dro. The held portion 13 has a held leg portion 14 that protrudes from the body outer peripheral surface 12o of the cylinder body 12 to the radial outer side Dro, and a hook portion 15 that is provided at an end of the held leg portion 14 on the radial outer side Dro and that protrudes from the held leg portion 14 to the axial high-pressure side Dah. The holding groove 25 or 25c has a leg insertion groove portion 28 and a hook insertion groove portion 27. The leg insertion groove portion 28 receives the held leg portion 14, and a width of the leg insertion groove portion 28 in the axial direction Da is greater than a width of the held leg portion 14 in the axial direction Da and smaller than a width of the hook portion 15 in the axial direction Da. The hook insertion groove portion 27 is located on the radial outer side Dro of the leg insertion groove portion 28, communicates with the leg insertion groove portion 28, and receives the hook portion 15, and a width of the hook insertion groove portion 27 in the axial direction Da is greater than a width of the hook portion 15 in the axial direction Da.

### INDUSTRIAL APPLICABILITY

According to one aspect of the present disclosure, it is possible to suppress deterioration in sealing performance and damage to a seal piece due to an inclination of a seal axis of a seal ring with respect to a rotational axis of a shaft.

### REFERENCE SIGNS LIST

1: shaft
S, Sa, Sb, Sc, Sx: seal device
10, 10b: seal ring
11, 11b: seal cylinder
11h: high-pressure-side surface
11l: low-pressure-side surface
11C, 11Cb, 11Cc, 11Cx: contact surface
12: cylinder body
12i: cylinder inner peripheral surface
12o: body outer peripheral surface
12h: body high-pressure-side surface
12l: body low-pressure-side surface
13: held portion
14: held leg portion
14h: leg high-pressure-side surface
14l: leg low-pressure-side surface
15: hook portion
15i: hook inner peripheral surface
15o: hook outer peripheral surface
15h: hook high-pressure-side surface
15l: hook low-pressure-side surface
16: protrusion portion
19: seal piece
20, 20a, 20b, 20c, 20x: seal holding ring
21: holding ring body
22: holding ring cylinder
23: high-pressure-side wall member
23a: high-pressure-side first wall member
23b: high-pressure-side second wall member
24, 24a, 24b, 24c, 24x: low-pressure-side wall member
25, 25c, 25x: holding groove
26: groove
25h: high-pressure-side holding groove side surface
25l: low-pressure-side holding groove side surface
25b: holding groove bottom surface
26l: low-pressure-side groove side surface
27: hook insertion groove portion
27h: high-pressure-side holding groove first side surface
27l: low-pressure-side holding groove first side surface
27r: radial movement restriction surface
28: leg insertion groove portion
28h: high-pressure-side holding groove second side surface
28l: low-pressure-side holding groove second side surface
29r: high-pressure-side inner peripheral surface
30: spacer
31: ring disk portion
31a: disk first side surface
31b: disk second side surface
32: tubular portion
Ga, Gr: gap
F: thrust load
M: moment
P1i: position of end of seal ring on radial inner side
P1o: position of end of contact surface on radial outer side
P1c: thrust load center
P2: position of end of contact surface on radial inner side
R1: thrust load center radius
R2: inner end radius
Ar: rotational axis
As: seal axis
Da: axial direction
Dah: axial high-pressure side
Dal: axial low-pressure side
Dc: circumferential direction
Dr: radial direction
Dri: radial inner side
Dro: radial outer side

1. A seal device comprising:
a seal ring that has an annular shape around a seal axis; and
a seal holding ring that has an annular shape around the seal axis and that holds the seal ring from an outer peripheral side of the seal ring,
wherein the seal holding ring has an annular holding groove that is recessed toward a radial outer side out of a radial inner side and the radial outer side in a radial direction with respect to the seal axis,
the seal ring has a seal cylinder that has an annular shape around the seal axis and that is partially inserted into the holding groove of the seal holding ring, and a plurality of seal pieces that have an annular shape around the seal axis and that are disposed on an inner peripheral side of the seal cylinder to be fixed to the seal cylinder,
the seal cylinder has, out of an axial high-pressure side and an axial low-pressure side in an axial direction in which the seal axis extends, a high-pressure-side surface facing the axial high-pressure side and a low-pressure-side surface facing the axial low-pressure side,
the holding groove is defined by a holding groove bottom surface facing the radial inner side, a high-pressure-side holding groove side surface facing the high-pressure-side surface of the seal cylinder in the axial direction, and a low-pressure-side holding groove side surface facing the low-pressure-side surface of the seal cylinder in the axial direction,
at least a part of the low-pressure-side surface of the seal cylinder forms a contact surface of the seal ring that allows contact with the low-pressure-side holding groove side surface of the seal holding ring in the axial direction,
the seal ring is divided into four or more parts in a circumferential direction with respect to the seal axis,
a ratio of an inner end radius to a thrust load center radius is 1.20 or less,
the thrust load center radius is a distance in the radial direction between the seal axis and a thrust load center, which is an intermediate position in the radial direction between a position closest to the radial outer side among portions of the seal ring that are in contact with the seal holding ring, and a position of the seal ring closest to the radial inner side, and
the inner end radius is a distance in the radial direction between the seal axis and a position of an end of the contact surface closest to the radial inner side.

2. The seal device according to claim 1,
wherein the seal ring is divided into six parts in the circumferential direction, and
the ratio of the inner end radius to the thrust load center radius is 1.10 or less.

3. The seal device according to claim 1,
wherein the seal ring is divided into eight parts in the circumferential direction, and
the ratio of the inner end radius to the thrust load center radius is 1.06 or less.

4. The seal device according to claim 1,
wherein the ratio of the inner end radius to the thrust load center radius is 1.0 or less.

5. The seal device according to claim 1,
wherein the seal cylinder has a cylinder inner peripheral surface which faces the inner peripheral side and from which the plurality of seal pieces protrude toward the radial inner side, and a protrusion portion that protrudes toward the radial inner side from the axial low-pressure side of the cylinder inner peripheral surface, and
at least a part of a surface of the protrusion portion facing the axial low-pressure side forms a part of the contact surface.

6. The seal device according to claim 1,
wherein the seal holding ring has a holding ring body that has an annular shape around the seal axis and that has an annular groove that is recessed toward the radial outer side, and a spacer having a portion entering the groove,
the holding groove is formed by the spacer and the groove,
the spacer comes into contact with at least a part of a low-pressure-side groove side surface facing the axial high-pressure side, among surfaces defining the groove, and comes into contact with at least a part of the low-pressure-side surface of the seal cylinder, and
the end of the contact surface closest to the radial inner side is an end closest to the radial inner side in a surface of the low-pressure-side surface of the seal cylinder that is in contact with the spacer.

7. The seal device according to claim 1,
wherein the seal cylinder has a cylinder body and a held portion inserted into the holding groove,
the cylinder body has a cylinder inner peripheral surface which faces the radial inner side and from which the plurality of seal pieces protrude to the radial inner side, and a body outer peripheral surface facing the radial outer side,
the held portion has a held leg portion that protrudes from the body outer peripheral surface of the cylinder body to the radial outer side, and a hook portion that is provided at an end of the held leg portion on the radial outer side and that protrudes from the held leg portion to the axial high-pressure side,
the holding groove has a leg insertion groove portion and a hook insertion groove portion,
the leg insertion groove portion receives the held leg portion, and a width of the leg insertion groove portion in the axial direction is greater than a width of the held leg portion in the axial direction and smaller than a width of the hook portion in the axial direction, and
the hook insertion groove portion is located on the radial outer side of the leg insertion groove portion, communicates with the leg insertion groove portion, and receives the hook portion, and a width of the hook insertion groove portion in the axial direction is greater than a width of the hook portion in the axial direction.
